(19) United States
(12) Patent Application Publication
(10) Pub. No.: US 2026/0185541 A1
(43) Pub. Date: Jul. 2, 2026

(54) COMPRESSOR MODULE

(71) Applicant: MITSUBISHI HEAVY INDUSTRIES COMPRESSOR CORPORATION, Hiroshima (JP)

(72) Inventors: Hirohisa Ueda, Hiroshima-shi (JP); Masayuki Fujii, Hiroshima-shi (JP); Hiroyuki Miyata, Hiroshima-shi (JP)

(73) Assignee: MITSUBISHI HEAVY INDUSTRIES COMPRESSOR CORPORATION, Hiroshima (JP)

(21) Appl. No.: 19/123,179

(22) PCT Filed: Oct. 26, 2023
(86) PCT No.: PCT/JP2023/038780

§ 371 Date: Apr. 22, 2025

(30) Foreign Application Priority Data
Oct. 31, 2022 (JP) 2022-174292

(51) Int. Cl. F04D 29/60; F04D 29/043; F04D 29/58

(52) U.S. Cl. CPC F04D 29/601; F04D 29/043; F04D 29/582

(57) ABSTRACT

A compressor module includes: a compressor; a gas supply device configured to supply a sealing gas to the compressor; a plurality of cooling units configured to cool a fluid compressed by the compressor; a first support part configured to support the compressor and the gas supply device; and a second support part fixed directly below the first support part in a vertical direction and configured to support two cooling units. The second support part is formed in a rectangular shape by a plurality of column parts and a plurality of beam parts. The first support part is transportable with the compressor and the gas supply device connected by piping being fixed. The second support part is transportable with the two cooling units being fixed.

### TECHNICAL FIELD

The present disclosure relates to a compressor module.

The present application claims priority to Japanese Patent Application No. 2022-174292 filed in Japan on Oct. 31, 2022, the contents of which are incorporated herein by reference.

### BACKGROUND ART

A compressor module in which a compressor that compresses a gaseous body such as air or gas and a rotary drive machine such as a motor or a turbine that drives the compressor are installed on a base plate is used in marine equipment such as a ship. In such a compressor module, a cooler that cools a fluid compressed by the compressor is also integrally provided.

For example, Patent Document 1 describes a compression device including a compressor and a plurality of coolers as a compressor module. In this compression device, the plurality of coolers are hung on a body support base on which the compressor is disposed and an ancillary support base connected to the body support base.

### CITATION LIST

### Patent Literature

Patent Document 1: JP 6060045 B

### SUMMARY OF INVENTION

### Technical Problem

The compressor module as described above has a large number of devices constituting the compressor module and a large number of pipes connecting the respective devices. This increases, in the installation place of the compressor module, on-site work for adjusting the position of the devices and installing the devices and pipe assembly and installation work for connecting a plurality of pipes. Thus, shortening the installation work of the compressor module is awaited.

The present disclosure provides a compressor module that can shorten installation work.

### Solution to Problem

A compressor module according to the present disclosure includes: a compressor including a rotor shaft that rotates about an axis and capable of compressing a fluid in stages; a gas supply device configured to supply a sealing gas to the compressor; a plurality of cooling units configured to cool a fluid compressed by the compressor; a first support part configured to support the compressor and the gas supply device from below in a vertical direction; and a second support part fixed directly below the first support part in the vertical direction and configured to support at least two of the cooling units from below in the vertical direction, wherein the second support part is formed in a rectangular shape by a plurality of column parts extending in the vertical direction and a plurality of beam parts extending in a horizontal direction, the first support part is transportable with the compressor and the gas supply device connected by piping being fixed, and the second support part is transportable with at least two cooling units being fixed.

### Advantageous Effects of Invention

The compressor module of the present disclosure allows installation work to be shortened.

### BRIEF DESCRIPTION OF DRAWINGS

FIG. 1 is a perspective view illustrating a schematic configuration of a compressor module according to an embodiment of the present disclosure.

FIG. 2 is a front view of the compressor module of the present embodiment as viewed from the front in an axial direction.

FIG. 3 is a top view of the compressor module of the present embodiment as viewed from above in a vertical direction.

FIG. 4 is a side view of the compressor module of the present embodiment as viewed from one side in a width direction.

FIG. 5 is a perspective view illustrating a schematic configuration of a first support part.

FIG. 6 is a perspective view illustrating a schematic configuration of a second support part.

### DESCRIPTION OF EMBODIMENTS

Hereinafter, a mode for implementing a compressor module 100 according to the present disclosure will be described with reference to the accompanying drawings. However, the present disclosure is not limited only to this embodiment.

### Configuration of Compressor Module

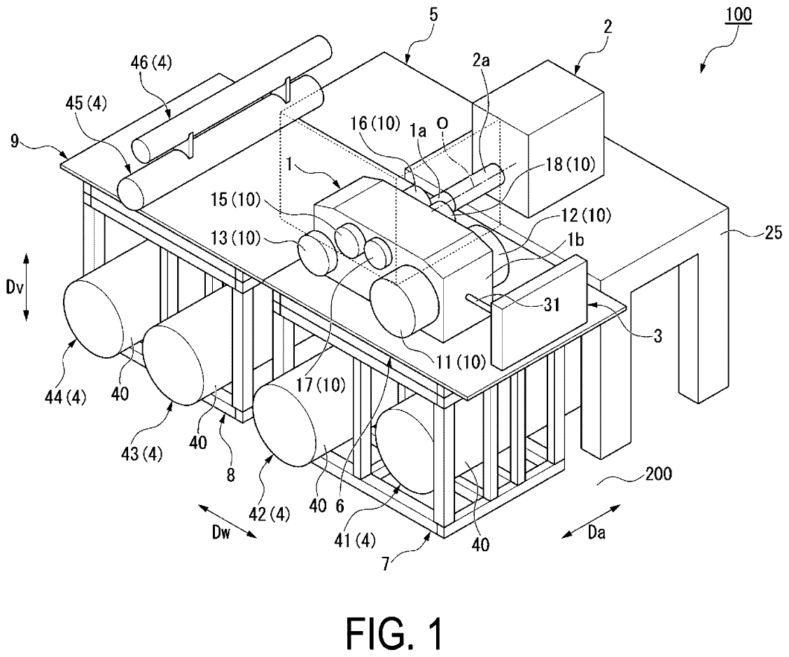

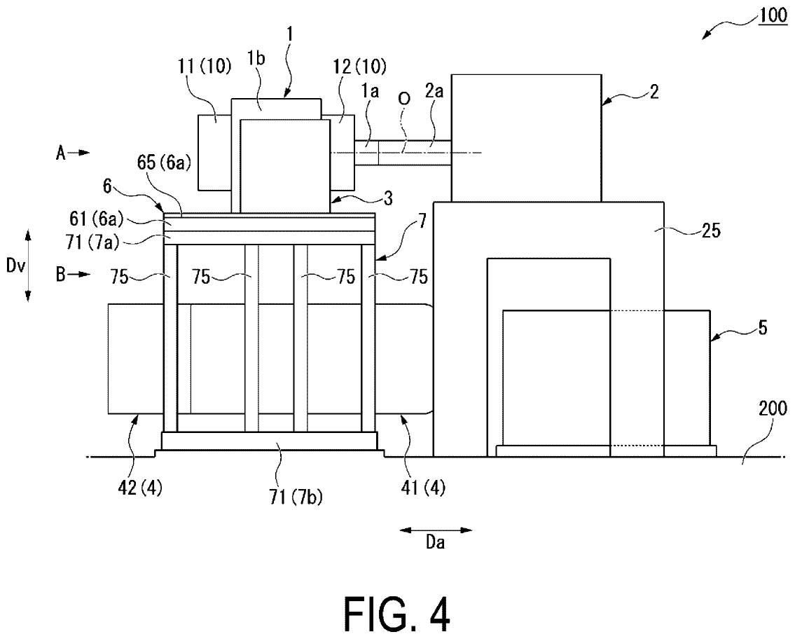

As illustrated in FIGS. 1 to 4, the compressor module 100 includes a compressor 1, a rotary drive machine 2, a gas supply device 3, a plurality of cooling units 4, an oil console device 5, a first support part 6, a second support part 7, a third support part 8, a fourth support part 9, and a drive support part 25.

### Compressor

The compressor 1 compresses gas as working fluid. The compressor 1 includes a rotor shaft la that rotates about an axis O. The rotor shaft la has a columnar shape centered on the axis O. The compressor 1 can compress gas (fluid) in stages. By including a plurality of compression units 10, the compressor 1 of the present embodiment can compress the gas in stages. The compressor 1 of the present embodiment is, for example, a geared compressor including an eight-stage compression unit 10. In the compressor 1, each of the compression units 10 includes one impeller (not illustrated).

The compressor 1 of the present embodiment further includes therein a gear casing 1b including a plurality of gears (not illustrated). The gear casing 1b can be divided into upper and lower portions. Removing the upper half portion of the gear casing 1b allows the internal gear to be visible. The gear can transmit the rotation of the rotor shaft la to a plurality of driven shafts (not illustrated). The driven shaft has both ends at which the compression units 10 are disposed and extends in an axial direction Da in parallel with the rotor shaft 1a. The rotation speeds of the plurality of (four in the present embodiment) driven shafts are set to be different from one another by the plurality of gears. The rotor shaft la extends so as to protrude to the outside of the gear casing 1b.

In the following description, a direction in which an axis O of the rotor shaft la described later extends is the axial direction Da. The axial direction Da is one of the horizontal directions. The horizontal direction is a direction in which a virtual plane orthogonal to a vertical direction Dv expands. One direction orthogonal to the axial direction Da in the horizontal direction is called a width direction Dw.

The plurality of compression units 10 are disposed outside the gear casing 1b. The compressor 1 of the present embodiment includes, as the compression units 10, a first compression unit 11, a second compression unit 12, a third compression unit 13, a fourth compression unit 14, a fifth compression unit 15, a sixth compression unit 16, a seventh compression unit 17, and an eighth compression unit 18.

The first compression unit 11 compresses a gas supplied from the outside of the compressor 1. The first compression unit 11 has the largest volume flow rate of the gas to be compressed among the plurality of compression units 10. The second compression unit 12 compresses the gas compressed by the first compression unit 11. The second compression unit 12 is rotated by the same driven shaft as that for the first compression unit 11. The volume flow rate of the gas compressed by the second compression unit 12 is smaller than that of the first compression unit 11.

The third compression unit 13 compresses the gas compressed by the second compression unit 12. The third compression unit 13 is rotated by a driven shaft different from that of the first compression unit 11 and the second compression unit 12. The volume flow rate of the gas compressed by the third compression unit 13 is smaller than that of the second compression unit 12. The fourth compression unit 14 compresses the gas compressed by the third compression unit 13. The fourth compression unit 14 is rotated by the same driven shaft as that for the third compression unit 13. The volume flow rate of the gas compressed by the fourth compression unit 14 is smaller than that of the third compression unit 13.

The fifth compression unit 15 compresses the gas compressed by the fourth compression unit 14. The fifth compression unit 15 is rotated by a driven shaft different from that of the third compression unit 13 and the fourth compression unit 14. The volume flow rate of the gas compressed by the fifth compression unit 15 is smaller than that of the fourth compression unit 14. The sixth compression unit 16 compresses the gas compressed by the fifth compression unit 15. The sixth compression unit 16 is rotated by the same driven shaft as that for the fifth compression unit 15. The volume flow rate of the gas compressed by the sixth compression unit 16 is smaller than that of the fifth compression unit 15.

The seventh compression unit 17 compresses the gas compressed by the sixth compression unit 16. The seventh compression unit 17 is rotated by a driven shaft different from that of the fifth compression unit 15 and the sixth compression unit 16. The volume flow rate of the gas compressed by the seventh compression unit 17 is smaller than that of the sixth compression unit 16. The eighth compression unit 18 compresses the gas compressed by the seventh compression unit 17. The eighth compression unit 18 is rotated by the same driven shaft as that for the seventh compression unit 17. The volume flow rate of the gas compressed by the eighth compression unit 18 is smaller than that of the seventh compression unit 17.

### Rotational Driving Machine

The rotary drive machine 2 is coupled to the compressor 1. The rotary drive machine 2 drives the compressor 1. The rotary drive machine 2 includes an output shaft 2a that is rotationally driven. The rotary drive machine 2 of the present embodiment is, for example, an electric motor. The rotary drive machine 2 always rotates the output shaft 2a at a constant speed. The output shaft 2a is rotationally driven about the axis O. The output shaft 2a has a columnar shape centered on the axis O. The output shaft 2a is connected to the rotor shaft 1a. This causes the rotation of the output shaft 2a to be transmitted to the rotor shaft 1a. The rotary drive machine 2 is not limited to a structure directly connected to the compressor 1 and may be a structure indirectly connected via a transmission or the like. The rotary drive machine 2 is disposed side by side at an interval in the axial direction Da with respect to the compressor 1. The output shaft 2a of the rotary drive machine 2 is greater in weight than the rotor shaft la of the compressor 1 and has a relatively low rotational frequency, and therefore excitation (resonance) due to a low-order vibration mode is likely to be caused during operation.

### Gas Supply Device

The gas supply device 3 can supply the compressor 1 with a sealing gas. The gas supply device 3 is connected to the compressor 1 by a plurality of pipes 31. The gas supply device 3 is disposed apart in the width direction Dw from the compressor 1. The gas supply device 3 of the present embodiment is a gas seal module (gas seal device: GSM). The gas supply device 3 is adjustable so that the pressure of the sealing gas is higher than that in the inside in order to prevent the sealing gas sent to a dry gas seal (not illustrated) disposed in the casing from flowing back at the dry gas seal.

### Cooling Unit

The plurality of cooling units 4 cool the gas compressed by the compressor 1. The cooling units 4 are disposed one by one between the stages of the two compression units 10. The cooling unit 4 of the present embodiment is a shell-and-tube heat exchanger. That is, the cooling unit 4 includes a shell 40 having a tubular part and a tube type heat exchanging unit (not illustrated) such as a cooling pipe disposed inside the shell 40. In the cooling unit 4, cooling water is used as a refrigerant. Each of the cooling units 4 cools the gas discharged from the compression unit 10 of the preceding stage and supplies the gas to the compression unit 10 of the following stage. The plurality of cooling units 4 of the present embodiment include a first cooling unit 41, a second cooling unit 42, a third cooling unit 43, a fourth cooling unit 44, a fifth cooling unit 45, and a sixth cooling unit 46.

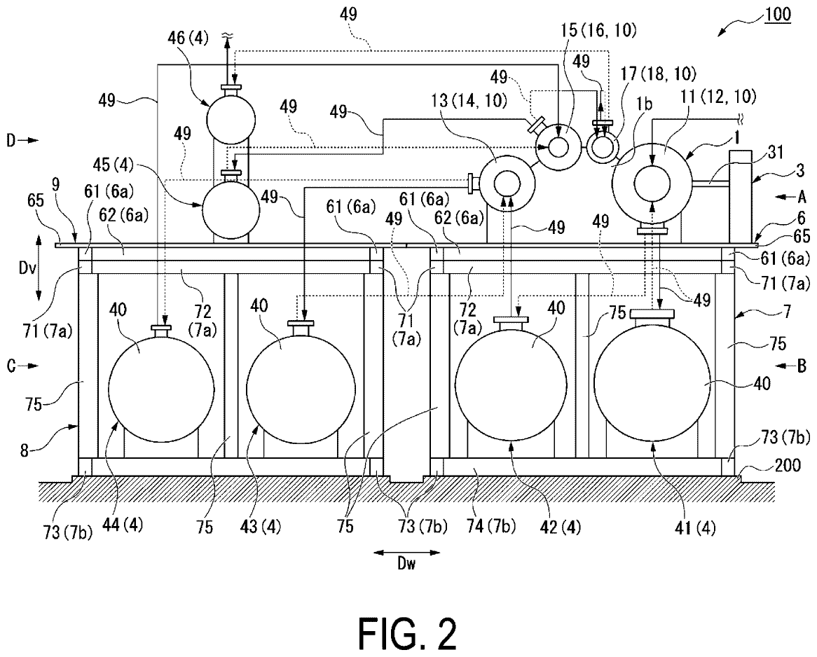

The first cooling unit 41 cools the gas compressed by the first compression unit 11. The first cooling unit 41 can supply the cooled gas to the second compression unit 12. The first cooling unit 41 is connected to the first compression unit 11 and the second compression unit 12 by an expansion joint 49 (see FIG. 2). That is, at least a part of a line (connection piping) connecting the first cooling unit 41 and the first compression unit 11 and a line (connection piping) connecting the first cooling unit 41 and the second compression unit 12 is made up of the expansion joint 49. The first cooling unit 41 has the largest volume among the plurality of cooling units 4. That is, the first cooling unit 41 can cool the largest amount of gas among the plurality of cooling units 4. The first cooling unit 41 has a bundle structure and is attachable to and detachable from the shell 40 when the heat exchanging unit disposed inside moves in the axial direction Da.

The second cooling unit 42 cools the gas compressed by the second compression unit 12. The second cooling unit 42 can supply the cooled gas to the third compression unit 13. The second cooling unit 42 is connected to the second compression unit 12 and the third compression unit 13 by the expansion joint 49 (see FIG. 2). That is, at least a part of a line (connection piping) connecting the second cooling unit 42 and the second compression unit 12 and a line (connection piping) connecting the second cooling unit 42 and the third compression unit 13 is made up of the expansion joint 49. The second cooling unit 42 has a volume equal to or smaller than that of the first cooling unit 41. Similarly to the first cooling unit 41, the second cooling unit 42 has a bundle structure.

The third cooling unit 43 cools the gas compressed by the third compression unit 13. The third cooling unit 43 can supply the cooled gas to the fourth compression unit 14. The third cooling unit 43 is connected to the third compression unit 13 and the fourth compression unit 14 by the expansion joint 49 (see FIG. 2). That is, at least a part of a line (connection piping) connecting the third cooling unit 43 and the third compression unit 13 and a line (connection piping) connecting the third cooling unit 43 and the fourth compression unit 14 is made up of the expansion joint 49. Similarly to the first cooling unit 41 and the second cooling unit 42, the third cooling unit 43 has a bundle structure.

The fourth cooling unit 44 cools the gas compressed by the fourth compression unit 14. The fourth cooling unit 44 can supply the cooled gas to the fifth compression unit 15. The fourth cooling unit 44 is connected to the fourth compression unit 14 and the fifth compression unit 15 by the expansion joint 49 (see FIG. 2). That is, at least a part of a line (connection piping) connecting the fourth cooling unit 44 and the fourth compression unit 14 and a line (connection piping) connecting the fourth cooling unit 44 and the fifth compression unit 15 is made up of the expansion joint 49. Similarly to the first cooling unit 41 to the third cooling unit 43, the fourth cooling unit 44 has a bundle structure.

The fifth cooling unit 45 cools the gas compressed by the fifth compression unit 15. The fifth cooling unit 45 can supply the cooled gas to the sixth compression unit 16. The fifth cooling unit 45 is connected to the fifth compression unit 15 and the sixth compression unit 16 by piping and the expansion joint 49 (see FIG. 2). That is, at least a part of a line (connection piping) connecting the fifth cooling unit 45 and the fifth compression unit 15 and a line (connection piping) connecting the fifth cooling unit 45 and the sixth compression unit 16 is made up of the piping and the expansion joint 49. The fifth cooling unit 45 is smaller in volume than the third cooling unit 43 and the fourth cooling unit 44.

The sixth cooling unit 46 cools the gas compressed by the eighth compression unit 18. The sixth cooling unit 46 is connected to the eighth compression unit 18 by piping and the expansion joint 49 (see FIG. 2). That is, at least a part of a line (connection piping) connecting the sixth cooling unit 46 and the eighth compression unit 18 is made up of the piping and the expansion joint 49. The sixth cooling unit 46 of the present embodiment is a recycle cooler that finally cools the gas having the highest pressure compressed by the compressor 1. The sixth cooling unit 46 can supply the cooled gas to a compression unit inlet inside the compressor module 100.

### Oil Console Device

The oil console device 5 supplies lubricating oil to the compressor 1 and the rotary drive machine 2. The oil console device 5 is made up of a plurality of devices (not illustrated), such as a tank, a pump, an oil cooler, and an oil filter. The oil console device 5 is disposed at a position not overlapping the compressor 1 and the rotary drive machine 2 in the horizontal direction when viewed from the vertical direction Dv. The oil console device 5 is disposed below the compressor 1 and the rotary drive machine 2 in the vertical direction Dv. The oil console device 5 is fixed to a base 200. That is, the oil console device 5 is disposed independently of the first support part 6, the second support part 7, the third support part 8, the fourth support part 9, and the drive support part 25.

### First Support Part

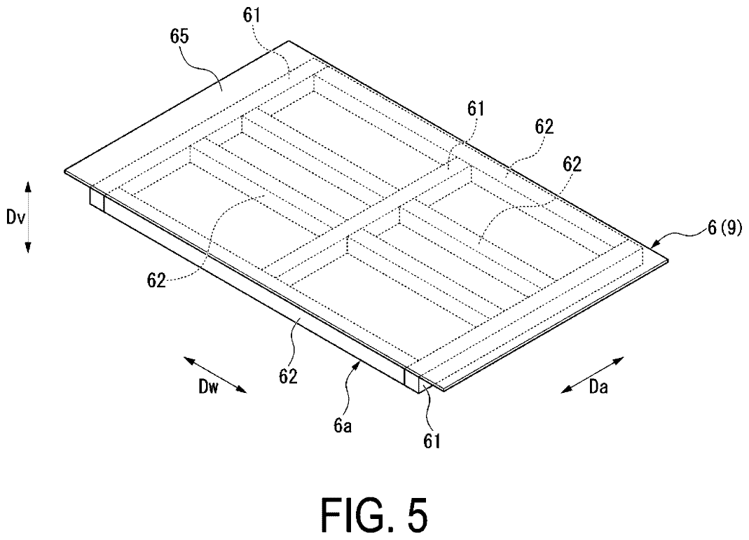

The first support part 6 supports the compressor 1 and the gas supply device 3 from below in the vertical direction Dv orthogonal to the horizontal direction. The first support part 6 is transportable with the compressor 1 and the gas supply device 3 connected by the plurality of pipes 31 being fixed. That is, the compressor 1 and the gas supply device 3 are fixed on the first support part 6. As illustrated in FIG. 5, the first support part 6 of the present embodiment includes a plurality of first vertical beam parts 61, a plurality of first horizontal beam parts 62, and a base plate body 65.

The first vertical beam part 61 is a columnar member extending in the axial direction Da. The plurality of first vertical beam parts 61 are disposed at intervals in the width direction Dw. In the present embodiment, three first vertical beam parts 61 are disposed evenly apart in the width direction Dw. The first vertical beam part 61 is, for example, H-shaped steel.

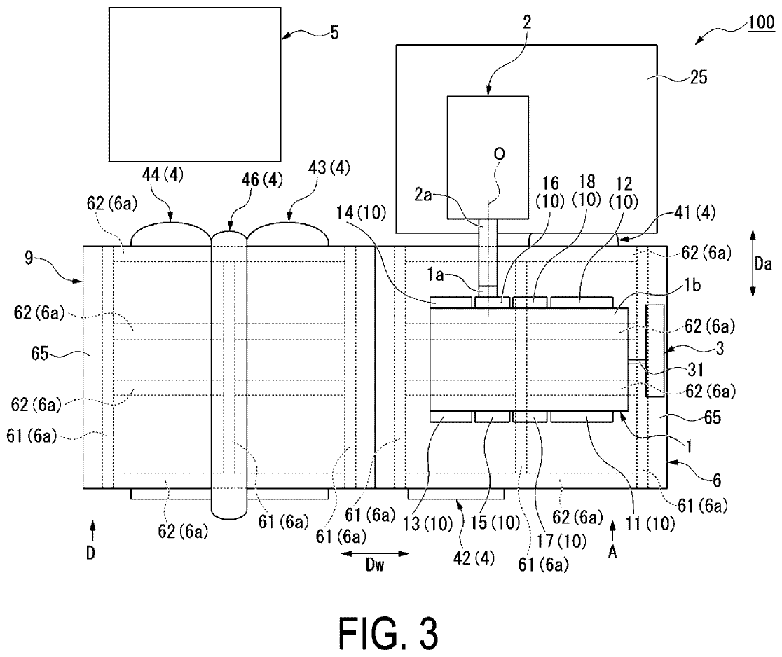

The first horizontal beam part 62 is a columnar member extending in the width direction Dw. The plurality of first horizontal beam parts 62 arc disposed at intervals in the axial direction Da. In the present embodiment, four first horizontal beam parts 62 are disposed apart in the axial direction Da. The first horizontal beam part 62 is, for example, H-shaped steel. The first horizontal beam part 62 is fixed to the first vertical beam part 61. A first frame body 6a having a rectangular shape is made up of the two first vertical beam parts 61 disposed outermost in the width direction Dw and the first horizontal beam part 62 disposed outermost in the axial direction Da. That is, the first frame body 6a is formed in a rectangular annular shape with a hollow inside when viewed from above in the vertical direction Dv. As illustrated in FIG. 3, in the first frame body 6a, the two first horizontal beam parts 62 disposed near the center in the axial direction Da are disposed at positions overlapping the compressor 1 and the gas supply device 3 when viewed from the vertical direction Dv.

As illustrated in FIG. 5, the base plate body 65 expands in the axial direction Da and the width direction Dw. The base plate body 65 of the present embodiment is a flat plate member having a rectangular shape including a large surface expanding in the horizontal direction. The base plate body 65 is disposed above the first frame body 6a in the vertical direction Dv. The base plate body 65 is fixed to the first frame body 6a. When viewed from above in the vertical direction Dv, the base plate body 65 is formed to have a size overlapping with the entire region of the plurality of first vertical beam parts 61 and the plurality of first horizontal beam parts 62. The base plate body 65 of the present embodiment is formed in a rectangular shape in which the length in the axial direction Da is equal to that of the first frame body 6a and the length in the width direction Dw is larger than that of the first frame body 6a when viewed from above in the vertical direction Dv. The base plate body 65 is not deformed even when a lightweight object such as a worker is placed thereon.

The compressor 1 and the gas supply device 3 are fixed to the base plate body 65 of the first support part 6.

As illustrated in FIGS. 1 to 4, the first support part 6 constitutes a first unit A together with the compressor 1 and the gas supply device 3. In the first unit A, all components are simultaneously transportable by a transport machine such as a crane.

### Second Support Part

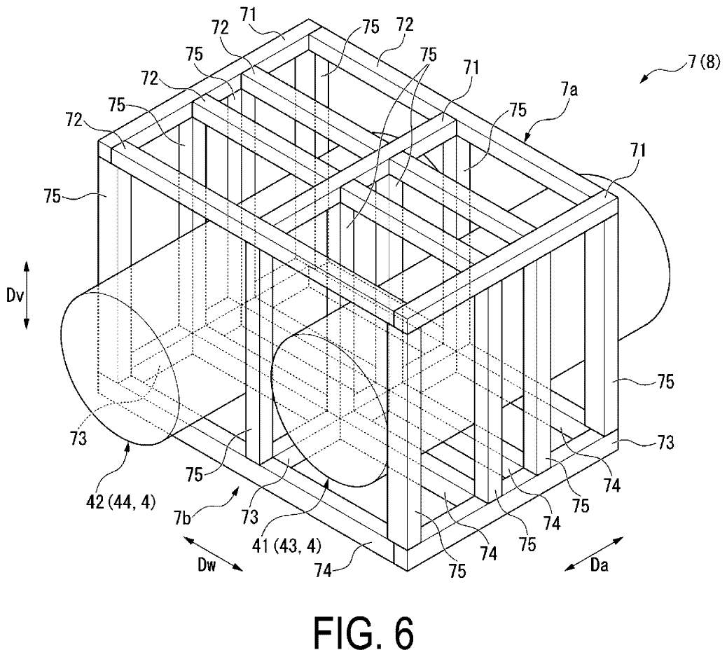

The second support part 7 is fixed directly below the first support part 6 in the vertical direction Dv. The second support part 7 supports at least two cooling units 4 from below in the vertical direction Dv. The second support part 7 is transportable with at least two cooling units 4 being fixed. The first cooling unit 41 and the second cooling unit 42 are fixed to the second support part 7 of the present embodiment. That is, the second support part 7 is transportable with the first cooling unit 41 and the second cooling unit 42 being fixed. The second support part 7 is fixed with the first support part 6. As illustrated in FIG. 6, the second support part 7 includes a second upper vertical beam part (beam part) 71, a second upper horizontal beam part (beam part) 72, a second lower vertical beam part (beam part) 73, a second lower horizontal beam part (beam part) 74, and a column part 75.

The second upper vertical beam part 71 is a member extending in the axial direction Da. A plurality of the second upper vertical beam parts 71 are disposed at intervals in the width direction Dw. In the present embodiment, three second upper vertical beam parts 71 arc disposed evenly apart in the width direction Dw. The second upper vertical beam part 71 is, for example, H-shaped steel. The second upper vertical beam part 71 is formed in the same shape as that of the first vertical beam part 61. The plurality of second upper vertical beam parts 71 are disposed at the same positions as those of the plurality of first vertical beam parts 61 when viewed from above in the vertical direction Dv.

As illustrated in FIG. 6, the second upper horizontal beam part 72 is a member extending in the width direction Dw. A plurality of the second upper horizontal beam parts 72 arc disposed at intervals in the axial direction Da. In the present embodiment, four second upper horizontal beam parts 72 are disposed apart in the axial direction Da. The second upper horizontal beam part 72 is, for example, H-shaped steel. The second upper horizontal beam part 72 is formed in the same shape as that of the first horizontal beam part 62. The plurality of second upper horizontal beam parts 72 are disposed at the same positions as those of the plurality of first horizontal beam parts 62 when viewed from above in the vertical direction Dv. The second upper horizontal beam part 72 is fixed to the second upper vertical beam part 71. A second upper frame body 7a having a rectangular shape is made up of the two second upper vertical beam parts 71 disposed outermost in the width direction Dw and the second upper horizontal beam part 72 disposed outermost in the axial direction Da.

That is, the second upper frame body 7a is formed in a rectangular annular shape with a hollow inside when viewed from above in the vertical direction Dv. The second upper frame body 7a is formed in the same shape as that of the first frame body 6a. The first frame body 6a is directly fixed to the second upper frame body 7a. The second upper frame body 7a is disposed above and away from the first cooling unit 41 and the second cooling unit 42 in the vertical direction Dv.

The second lower vertical beam part 73 is a member extending in the axial direction Da. A plurality of the second lower vertical beam parts 73 are disposed at intervals in the width direction Dw. In the present embodiment, three second lower vertical beam parts 73 are disposed evenly apart in the width direction Dw. The second lower vertical beam part 73 is, for example, H-shaped steel. The second lower vertical beam part 73 is formed in the same shape as that of the second upper vertical beam part 71. The plurality of second lower vertical beam parts 73 are disposed at the same positions as those of the plurality of second upper vertical beam parts 71 when viewed from above in the vertical direction Dv.

The second lower horizontal beam part 74 is a member extending in the width direction Dw. A plurality of the second lower horizontal beam parts 74 are disposed at intervals in the axial direction Da. In the present embodiment, four second lower horizontal beam parts 74 are disposed apart in the axial direction Da. The second lower horizontal beam part 74 is, for example, H-shaped steel. The second lower horizontal beam part 74 is formed in the same shape as that of the second upper horizontal beam part 72. The plurality of second lower horizontal beam parts 74 arc disposed at the same positions as those of the plurality of second upper horizontal beam parts 72 when viewed from above in the vertical direction Dv. The second lower horizontal beam part 74 is fixed to the second lower vertical beam part 73. A second lower frame body 7b having a rectangular shape is made up of the two second lower vertical beam parts 73 disposed outermost in the width direction Dw and the second lower horizontal beam part 74 disposed outermost in the axial direction Da.

That is, the second lower frame body 7b is formed in a rectangular shape with a hollow inside when viewed from above in the vertical direction Dv. The second lower frame body 7b is formed in the same shape as that of the second upper frame body 7a. The second lower frame body 7b is directly fixed to the base 200. The second lower frame body 7b is fixed below the first cooling unit 41 and the second cooling unit 42 in the vertical direction Dv.

The column part 75 is a columnar member extending in the vertical direction Dv. The plurality of column parts 75 are disposed at intervals in the horizontal direction (the width direction Dw and the axial direction Da). At least one of the plurality of column parts 75 is disposed between the first cooling unit 41 and the second cooling unit 42 in the horizontal direction and at a position overlapping the compressor 1 when viewed from the direction in which the axis O extends. In the present embodiment, three sets of four column parts 75 disposed apart in the axial direction Da are disposed apart in the width direction Dw. The four column parts 75 disposed apart in the axial direction Da are disposed at positions overlapping the plurality of second upper vertical beam parts 71 and second lower vertical beam parts 73 when viewed from above in the vertical direction Dv. The three column parts 75 disposed apart in the width direction Dw are disposed at positions overlapping the plurality of second upper horizontal beam parts 72 and the plurality of second lower horizontal beam parts 74 when viewed from above in the vertical direction Dv. The column part 75 that is the middle one of the three column parts 75 disposed apart in the width direction Dw is disposed between the first cooling unit 41 and the second cooling unit 42 in the width direction Dw. The two column parts 75 that are the middle two of the four column parts 75 disposed apart in the axial direction Da, the two column parts 75 disposed at the center in the width direction Dw are disposed at positions overlapping the gear casing 1b when viewed from above in the vertical direction Dv. The column part 75 is, for example, H-shaped steel. Both ends of the plurality of column parts 75 are fixed to the second upper frame body 7a and the second lower frame body 7b, respectively.

In this manner, the second support part 7 has a Rahmen structure formed in a rectangular shape by the plurality of column parts 75, the second upper frame body 7a, and the second lower frame body 7b. That is, the Rahmen structure is formed by the plurality of column parts 75 extending in the vertical direction Dv, the plurality of second upper vertical beam parts 71 and second lower vertical beam parts 73 extending in the axial direction Da, which is one of the horizontal directions, and the plurality of second upper horizontal beam parts 72 and second lower horizontal beam parts 74 extending in the width direction Dw, which is one of the horizontal directions. The Rahmen structure in the present embodiment also includes a structure reinforced by a brace in addition to the above-described members.

The first cooling unit 41 and the second cooling unit 42 are fixed to a space inside the second support part 7 formed by the Rahmen structure. As illustrated in FIGS. 1 to 4, the second support part 7 constitutes a second unit B together with the first cooling unit 41 and the second cooling unit 42. In the second unit B, all components are simultaneously transportable by a transport machine such as a crane.

### Third Support Part

The third support part 8 is disposed adjacent to the second support part 7 in the width direction Dw. The third support part 8 supports at least two cooling units 4 different from the second support part 7 from below in the vertical direction Dv. The third cooling unit 43 and the fourth cooling unit 44 are fixed to the third support part 8 of the present embodiment. The third support part 8 is transportable with the third cooling unit 43 and the fourth cooling unit 44 being fixed. The third support part 8 is formed to have the same structure as that of the second support part 7. That is, similarly to the second support part 7, the third support part 8 also has a Rahmen structure formed in a rectangular shape by the plurality of column parts 75 extending in the vertical direction Dv and the plurality of beam parts extending in the horizontal direction. Therefore, similarly to the second support part 7, the third support part 8 includes the second upper vertical beam part 71, the second upper horizontal beam part 72, the second lower vertical beam part 73, the second lower horizontal beam part 74, and the column part 75. In the third support part 8, the column part 75 that is the middle one of the three column parts 75 disposed apart in the width direction Dw is disposed between the third cooling unit 43 and the fourth cooling unit 44 in the width direction Dw. Furthermore, the column part 75 that is the middle one is disposed at a position overlapping the fifth cooling unit 45 and the sixth cooling unit 46 when viewed from above in the vertical direction Dv.

The third cooling unit 43 and the fourth cooling unit 44 are fixed to a space inside the third support part 8 formed by the Rahmen structure. The third support part 8 constitutes a third unit C together with the third cooling unit 43 and the fourth cooling unit 44. In the third unit C, all components are simultaneously transportable by a transport machine such as a crane.

### Fourth Support Part

The fourth support part 9 is disposed above the third support part 8 in the vertical direction Dv, adjacent to the first support part 6 in the width direction Dw. The fourth support part 9 is fixed to the third support part 8. The fourth support part 9 supports at least two cooling units 4 different from the second support part 7 and the third support part 8 from below in the vertical direction Dv. The fifth cooling unit 45 and the sixth cooling unit 46 are fixed to the fourth support part 9 of the present embodiment. The fourth support part 9 is transportable with the fifth cooling unit 45 and the sixth cooling unit 46 being fixed. The fourth support part 9 is formed to have the same structure as that of the first support part 6. Therefore, similarly to the first support part 6, the fourth support part 9 also includes the plurality of first vertical beam parts 61, the plurality of first horizontal beam parts 62, and the base plate body 65. The fifth cooling unit 45 is fixed to the base plate body 65 of the fourth support part 9.

The fourth support part 9 constitutes a fourth unit D together with the fifth cooling unit 45 and the sixth cooling unit 46. In the fourth unit D, all components are simultaneously transportable by a transport machine such as a crane.

### Drive Support Part

The drive support part 25 supports the rotary drive machine 2 from below in the vertical direction Dv. The drive support part 25 is disposed so as to be next to the first support part 6 in the axial direction Da. The drive support part 25 is formed such that the position of the output shaft 2a of the rotary drive machine 2 and the position of the rotor shaft la of the compressor 1 are arranged at the same position (level) in the vertical direction Dv. The drive support part 25 is formed as a gate-shaped base formed of concrete higher in rigidity than the first support part 6 and the second support part 7, for example. The drive support part 25 is directly fixed to the base 200. The drive support part 25 is disposed independently of the first support part 6, the second support part 7, the third support part 8, and the fourth support part 9.

### Actions and Effects

In the compressor module 100 configured as described above, the first support part 6 is fixed on the second support part 7 having a Rahmen structure. The first support part 6 constitutes the first unit A that is transportable with the compressor 1 and the gas supply device 3 being fixed. The second support part 7 constitutes the second unit B that is transportable with the first cooling unit 41 and the second cooling unit 42 being fixed. Therefore, the first cooling unit 41 and the second cooling unit 42 that are fixed in a certain position (unmovable state) can be arranged at designated installation positions only by transporting the second support part 7. Therefore, installation work of the first cooling unit 41 and the second cooling unit 42 can be shortened. Similarly, only transporting and fixing, on the second support part 7, the first support part 6 allows the compressor 1 and the gas supply device 3 that are fixed in a certain position state to be arranged at installation positions of the compressor module 100. In particular, the compressor 1 and the gas supply device 3 have already been connected to the pipe 31. Therefore, after the compressor 1 and the gas supply device 3 are arranged, the work of separately connecting the pipe 31 between the compressor 1 and the gas supply device 3 is unnecessary. Therefore, installation work of the compressor 1 and the gas supply device 3 can be shortened. These can shorten installation work as the compressor module 100.

The gear casing 1b of the compressor 1 can be divided into upper and lower portions. Such a compressor 1 is fixed on the first support part 6 fixed on the second support part 7. Therefore, the first support part 6 has nothing disposed above the compressor 1 in the vertical direction Dv. Therefore, the upper half portion of the gear casing 1b can be removed to maintain accessibility during maintenance.

The gas supply device 3 is fixed on the first support part 6 side by side with the compressor 1. The first support part 6 has nothing disposed above the gas supply device 3 in the vertical direction Dv. Therefore, the gas supply device 3 can be maintained independently of the compressor 1. The gas supply device 3 may be maintained while the compressor 1 is in operation, but even in such a case, maintainability of the gas supply device 3 can be ensured.

The first cooling unit 41 having the largest volume among the plurality of cooling units 4 is fixed to the second support part 7 together with the second cooling unit 42. Therefore, the cooling unit 4 having a large weight among the plurality of cooling units 4 is disposed below the compressor 1 in the vertical direction Dv. Therefore, even if the compressor 1 is disposed at a high position with respect to the base 200 as in the case of the first support part 6 on the second support part 7, the compressor 1 can be stably supported by the first cooling unit 41 and the second cooling unit 42, which are heavy items.

The second support part 7 is fixed directly below the first support part 6 in the vertical direction Dv. Therefore, the positions of the first cooling unit 41 and the second cooling unit 42 and the compressor 1 can be brought close to each other. Therefore, the connection piping such as the expansion joint 49 connecting the first cooling unit 41 and the second cooling unit 42 to the compressor 1 can be shortened.

The first cooling unit 41 is connected to each of the first compression unit 11 and the second compression unit 12 by the expansion joint 49. Similarly, the second cooling unit 42 is connected to each of the second compression unit 12 and the third compression unit 13 by the expansion joint 49. Therefore, even if the positions of the first cooling unit 41 and the second cooling unit 42 and the compressor 1 arc displaced when the first support part 6 and the second support part 7 are fixed, an installation error between the compression unit 10 and the cooling unit 4 can be absorbed by the expansion joint 49.

The second support part 7 includes two column parts 75 between the first cooling unit 41 and the second cooling unit 42 and at a position overlapping with the compressor 1 when viewed from the axial direction Da. Therefore, the compressor 1 can be supported from below in the vertical direction Dv by the two column parts 75. As a result, compared to a case where the compressor 1 is supported only by the first upper frame body and the second upper frame body 7a, the support rigidity in the vertical direction Dv with respect to the compressor 1 can be enhanced.

In particular, in the present embodiment, the first horizontal beam part 62, the second upper horizontal beam part 72, and the second lower horizontal beam part 74 are also disposed at positions overlapping the compressor 1 when viewed in the vertical direction Dv. The second support part 7 has a Rahmen structure. Therefore, the support rigidity in the vertical direction Dv with respect to the compressor 1 can be further enhanced. This causes the compressor 1 to be disposed at a high position with respect to the second support part 7 and can thus maintain the second support part 7 in a stable state against this pulling force even if a force of pulling (pulling force) is generated in the column part 75 due to the weight of the compressor 1. Therefore, the compressor 1 disposed at a high position can be stably supported.

The third cooling unit 43 and the fourth cooling unit 44 are fixed to the third support part 8 having a Rahmen structure similarly to the second support part 7. The third support part 8 is disposed adjacent to the second support part 7 in the width direction Dw. The third support part 8 constitutes the third unit C that is transportable with the third cooling unit 43 and the fourth cooling unit 44 being fixed. Therefore, the third cooling unit 43 and the fourth cooling unit 44 that are fixed in a certain position can be arranged at designated installation positions only by transporting the third support part 8. Therefore, installation work of the third cooling unit 43 and the fourth cooling unit 44 can be shortened. That is, use of not only the first unit A and the second unit B but also the third unit C can shorten installation work of more cooling units 4, further shortening setup work as the compressor module 100.

The first cooling unit 41 and the second cooling unit 42 disposed inside the second support part 7 and the third cooling unit 43 and the fourth cooling unit 44 disposed inside the third support part 8 have a bundle structure in which the heat exchanging unit, which is an internal component, is attachable to and detachable from the shell 40 by moving in the axial direction Da. Therefore, even when the second upper frame body 7a is disposed above the cooling unit 4, maintainability of the cooling unit 4 is not impaired.

The fifth cooling unit 45 and the sixth cooling unit 46 arc fixed to the fourth support part 9. The fourth support part 9 is disposed adjacent to the first support part 6 in the width direction Dw. The fourth support part 9 constitutes the fourth unit D that is transportable with the fifth cooling unit 45 and the sixth cooling unit 46 being fixed. Therefore, the fifth cooling unit 45 and the sixth cooling unit 46 that are fixed in a certain position can be arranged at designated installation positions only by transporting the fourth support part 9. Therefore, installation work of the fifth cooling unit 45 and the sixth cooling unit 46 can be shortened. That is, use of not only the first unit A to the third unit C but also the fourth unit D can shorten installation work of yet more cooling units 4, further shortening setup work as the compressor module 100.

The fourth support part 9 is disposed not at a position next to the second support part 7 and the third support part 8 in the width direction Dw but above the third support part 8 in the vertical direction Dv and adjacent to the first support part 6 in the width direction Dw. Therefore, the positions of the fifth cooling unit 45 and the sixth cooling unit 46 and the compressor 1 can be brought close to each other. Therefore, the connection piping such as the expansion joint 49 connecting the fifth cooling unit 45 and the sixth cooling unit 46 to the compressor 1 can be shortened.

Unlike the first support part 6 and the second support part 7, the rotary drive machine 2 is supported by the drive support part 25, which is a concrete base, with respect to the base 200. The rotary drive machine 2 that allows the compressor 1 to be driven is greater in weight than the compressor 1, and the vibration during operation tends to be large. In such a rotary drive machine 2, the drive support part 25 is fixed to the base 200 at a position independent of the first support part 6 and the second support part 7. Therefore, the first support part 6 and the second support part 7 arc suppressed from being adversely affected by the weight and vibration of the rotary drive machine 2.

The oil console device 5 is disposed below the compressor 1 and the rotary drive machine 2 in the vertical direction Dv. Therefore, a gradient for recovering the lubricating oil used in the compressor 1 and the rotary drive machine 2 is easily ensured. Furthermore, the oil console device 5 is directly fixed to the base 200 independently of the first support part 6, the second support part 7, the third support part 8, the fourth support part 9, and the drive support part 25. Therefore, nothing is disposed above the oil console device 5 in the vertical direction Dv. Therefore, accessibility during maintenance to the oil console device 5 including a plurality of devices from above in the vertical direction Dv can be ensured. The oil console device 5 having a plurality of devices may be required to have a large installation space. Even in such a case, an installation space is easily ensured by being directly fixed to the base 200.

### Other Embodiments

Although the embodiment of the present disclosure has been described in detail with reference to the accompanying drawings, specific configurations are not limited to this embodiment, and design changes and the like without departing from the gist of the present disclosure are also included.

The compressor 1 is not limited to a geared compressor and may be another type of the compressor 1 such as a multistage centrifugal compressor.

The rotary drive machine 2 is not limited to an electric motor, and it may be one that can drive the compressor 1. Therefore, the rotary drive machine 2 may be a steam turbine or a gas turbine.

The configuration of the compressor module 100 of the present embodiment is not limited to the configuration of the above embodiment. For example, the compressor module 100 may have a configuration not including the fourth unit D and the third unit C but including only the first unit A and the second unit B.

The configuration is not limited to a configuration in which only the compressor 1 and the gas supply device 3 are fixed on the first support part 6. For example, another cooling unit 4 may be fixed on the first support part unit 6. The configuration is not limited to a configuration in which only the first cooling unit 41 and the second cooling unit 42 are fixed to the second support part 7. Three or more cooling units 4 including other cooling units 4 may be fixed to the second support part 7. Similarly, the configuration is not limited to a configuration in which only the third cooling unit 43 and the fourth cooling unit 44 are fixed to the third support part 8. Three or more cooling units 4 including other cooling units 4 may be fixed to the third support part 8.

The structures of the first support part 6, the second support part 7, the third support part 8, and the fourth support part 9 are not limited to the above-described structures. Furthermore, the first support part 6, the second support part 7, the third support part 8, and the fourth support part 9 may have different structures from one another.

### Supplementary Notes

The compressor module 100 described in the embodiment is understood as follows, for example.

(1) The compressor module 100 according to a first aspect includes: the compressor 1 including the rotor shaft 1a that rotates about the axis O and capable of compressing a fluid in stages; the gas supply device 3 configured to supply a sealing gas to the compressor 1; the plurality of cooling units 4 configured to cool a fluid compressed by the compressor 1; the first support part 6 configured to support the compressor 1 and the gas supply device 3 from below in the vertical direction Dv; and the second support part 7 fixed directly below the first support part 6 in the vertical direction Dv and configured to support at least two of the cooling units 4 from below in the vertical direction Dv, wherein the second support part 7 is formed in a rectangular shape by the plurality of column parts 75 extending in the vertical direction Dv and a plurality of beam parts extending in the horizontal direction, the first support part 6 is transportable with the compressor 1 and the gas supply device 3 connected by the piping 31 being fixed, and the second support part 7 is transportable with at least two of the cooling units 4 being fixed.

This allows at least two cooling units 4 that are fixed in a certain position to be arranged at designated installation positions only by transporting the second support part 7. Therefore, installation work of the cooling unit 4 can be shortened. Similarly, only transporting and fixing, on the second support part 7, the first support part 6 allows the compressor 1 and the gas supply device 3 that are fixed in a certain position state to be arranged at the installation positions of the compressor module 100. In particular, the compressor 1 and the gas supply device 3 have already been connected to the pipe 31. Thus, after the compressor 1 and the gas supply device 3 are arranged, the work of separately connecting the pipe 31 between the compressor 1 and the gas supply device 3 is unnecessary. Therefore, installation work of the compressor 1 and the gas supply device 3 can be shortened. These can shorten installation work as the compressor module 100.

(2) The compressor module 100 according to a second aspect is the compressor module 100 of (1), wherein the compressor 1 at least includes the first compression unit 11 configured to compress the fluid and the second compression unit 12 configured to compress the fluid compressed by the first compression unit 11, the plurality of cooling units 4 at least include the first cooling unit 41 configured to cool and capable of supplying, to the second compression unit 12, the fluid compressed by the first compression unit 11 and the second cooling unit 42 configured to cool and capable of supplying, to the third compression unit 13, the fluid compressed by the second compression unit 12, the first cooling unit 41 has a largest volume among the plurality of cooling units 4, and the second support part 7 is transportable with the first cooling unit 41 and the second cooling unit 42 being fixed.

This causes the cooling unit 4 having a large weight among the plurality of cooling units 4 to be disposed below the compressor 1 in the vertical direction Dv. Therefore, even if the compressor 1 is disposed at a high position, the compressor 1 can be stably supported by the first cooling unit 41 and the second cooling unit 42, which are heavy items.

(3) The compressor module 100 according to a third aspect is the compressor module 100 of (2), wherein the first cooling unit 41 and the second cooling unit 42 are each connected to the compressor 1 by the expansion joint 49.

This allows, even if the positions of the first cooling unit 41 and the second cooling unit 42 and the compressor 1 are displaced when the first support part 6 and the second support part 7 are fixed, an installation error between the compression unit 10 and the cooling unit 4 to be absorbed by the expansion joint 49.

(4) The compressor module 100 according to a fourth aspect is the compressor module 100 of any one of (2) to (4), wherein the second support part 7 includes at least one column part 75 between the first cooling unit 41 and the second cooling unit 42 in the horizontal direction and at a position overlapping the compressor 1 when viewed from the direction in which the axis O extends.

This allows the compressor 1 to be supported by at least one column part 75 from below in the vertical direction Dv. As a result, the support rigidity in the vertical direction Dv with respect to the compressor 1 can be enhanced as compared with the case where the compressor 1 is supported only by the beam member extending in the horizontal direction.

(5) The compressor module 100 according to a fifth aspect is the compressor module 100 of any one of (2) to (5) including the third support part 8 different from the second support part 7 and configured to support at least two of the cooling units 4 from below in the vertical direction Dv, wherein the compressor 1 further includes the third compression unit 13 configured to compress the fluid compressed by the second compression unit 12 and the fourth compression unit 14 configured to compress the fluid compressed by the third compression unit 13, the plurality of cooling units 4 further include the third cooling unit 43 configured to cool and capable of supplying, to the fourth compression unit 14, the fluid compressed by the third compression unit 13 and the fourth cooling unit 44 capable of cooling the fluid compressed by the fourth compression unit 14, the third support part 8 is formed in a rectangular shape by the plurality of column parts 75 extending in the vertical direction Dv and a plurality of beam parts extending in the horizontal direction, and the third support part 8 is disposed adjacent to the second support part 7 in the horizontal direction and is transportable with the third cooling unit 43 and the fourth cooling unit 44 being fixed.

This allows the third cooling unit 43 and the fourth cooling unit 44 that are fixed in a certain position to be arranged at the designated installation positions only by transporting the third support part 8. Therefore, installation work of the third cooling unit 43 and the fourth cooling unit 44 can be shortened. That is, installation work of more cooling units 4 can be shortened, further shortening setup work as the compressor module 100.

(6) The compressor module 100 according to a sixth aspect is the compressor module 100 of any one of (2) to (5) including the fourth support part 9 different from the second support part 7 and the third support part 8 and configured to support at least two of the cooling units 4 from below in the vertical direction Dv, wherein the compressor 1 further includes the fifth compression unit 15 configured to compress the fluid compressed by the fourth compression unit 14 and the sixth compression unit 16 configured to compress the fluid compressed by the fifth compression unit 15, the plurality of cooling units 4 further include the fifth cooling unit 45 configured to cool and capable of supplying, to the sixth compression unit 16, the fluid compressed by the fifth compression unit 15 and the sixth cooling unit 46 capable of cooling the fluid compressed by the sixth compression unit 16, and the fourth support part 9 is disposed above the third support part 8 in the vertical direction Dv and adjacent to the first support part 6 in the horizontal direction and is transportable with the fifth cooling unit 45 and the sixth cooling unit 46 being fixed.

This allows the fifth cooling unit 45 and the sixth cooling unit 46 that are fixed in a certain position to be arranged at the designated installation positions only by transporting the fourth support part 9. Therefore, installation work of the fifth cooling unit 45 and the sixth cooling unit 46 can be shortened. That is, installation work of yet more cooling units 4 can be shortened, further shortening setup work as the compressor module 100.

(7) The compressor module 100 according to a seventh aspect is the compressor module 100 of any one of (1) to (6) further including the rotary drive machine 2 including the output shaft 2a rotationally driven about the axis O and allowing the compressor 1 to be driven by transmitting rotation of the output shaft 2a, wherein the rotary drive machine 2 is disposed at a position not overlapping the first support part 6 and the second support part 7 when viewed from the vertical direction Dv and is aligned with the compressor 1 in the axial direction Da in which the axis O extends.

This causes the drive support part 25 to be fixed at a position with the rotational driving machine 2 being independent of the first support part 6 and the second support part 7. Therefore, the first support part 6 and the second support part 7 arc suppressed from being adversely affected by the weight and vibration of the rotary drive machine 2.

### Industrial Applicability

The compressor module of the present disclosure allows installation work to be shortened.

### Reference Signs List

100 Compressor module
1 Compressor
1a Rotor shaft
O Axis
10 Compression unit
11 First compression unit
12 Second compression unit
13 Third compression unit
14 Fourth compression unit
15 Fifth compression unit
16 Sixth compression unit
17 Seventh compression unit
18 Eighth compression unit
1b Gear casing
2 Rotary drive machine
2a Output shaft
3 Gas supply device
31 Pipe
4 Cooling unit
40 Shell
41 First cooling unit
42 Second cooling unit
43 Third cooling unit
44 Fourth cooling unit
45 Fifth cooling unit
46 Sixth cooling unit
49 Expansion joint
5 Oil console device
6 First support part
61 First vertical beam part
62 First horizontal beam part
65 Base plate body
6a First frame body
7 Second support part
71 Second upper vertical beam part
72 Second upper horizontal beam part
73 Second lower vertical beam part
74 Second lower horizontal beam part
75 Column part
7a Second upper frame body
7b Second lower frame body
8 Third support part
9 Fourth support part
A First unit
B Second unit
C Third unit
D Fourth unit
25 Drive support part
200 Base
Da Axial direction
Dw Width direction
Dv Vertical direction

1. A compressor module, comprising:
a compressor including a rotor shaft that rotates about an axis and capable of compressing a fluid in stages;
a gas supply device configured to supply a sealing gas to the compressor;
a plurality of cooling units configured to cool a fluid compressed by the compressor;
a first support part configured to support the compressor and the gas supply device from below in a vertical direction; and
a second support part fixed directly below the first support part in the vertical direction and configured to support at least two of the cooling units from below in the vertical direction, wherein
the second support part is formed in a rectangular shape by a plurality of column parts extending in the vertical direction and a plurality of beam parts extending in a horizontal direction,
the first support part is transportable with the compressor and the gas supply device connected by piping being fixed, and
the second support part is transportable with at least two of the cooling units being fixed.

2. The compressor module according to claim 1, wherein
the compressor at least includes
a first compression unit configured to compress the fluid and
a second compression unit configured to compress the fluid compressed by the first compression unit,
the plurality of cooling units at least include
a first cooling unit configured to cool and capable of supplying, to the second compression unit, the fluid compressed by the first compression unit and
a second cooling unit capable of cooling the fluid compressed by the second compression unit,
the first cooling unit has a largest volume among the plurality of cooling units, and
the second support part is transportable with the first cooling unit and the second cooling unit being fixed.

3. The compressor module according to claim 2, wherein the first cooling unit and the second cooling unit are each connected to the compressor by an expansion joint.

4. The compressor module according to claim 2, wherein the second support part includes at least one column part between the first cooling unit and the second cooling unit in the horizontal direction and at a position overlapping the compressor when viewed from a direction in which the axis extends.

5. The compressor module according to claim 2, comprising
a third support part different from the second support part and configured to support at least two of the cooling units from below in the vertical direction, wherein
the compressor further includes
a third compression unit configured to compress the fluid compressed by the second compression unit and
a fourth compression unit configured to compress the fluid compressed by the third compression unit,
the plurality of cooling units further include
a third cooling unit configured to cool and capable of supplying, to the fourth compression unit, the fluid compressed by the third compression unit and
a fourth cooling unit capable of cooling the fluid compressed by the fourth compression unit,
the third support part is formed in a rectangular shape by the plurality of column parts extending in the vertical direction and the plurality of beam parts extending in the horizontal direction, and
the third support part is disposed adjacent to the second support part in the horizontal direction and is transportable with the third cooling unit and the fourth cooling unit being fixed.

6. The compressor module according to claim 5, comprising
a fourth support part different from the second support part and the third support part and configured to support at least two of the cooling units from below in the vertical direction, wherein
the compressor further includes
a fifth compression unit configured to compress the fluid compressed by the fourth compression unit and
a sixth compression unit configured to compress the fluid compressed by the fifth compression unit,
the plurality of cooling units further include
a fifth cooling unit configured to cool and capable of supplying, to the sixth compression unit, the fluid compressed by the fifth compression unit and
a sixth cooling unit capable of cooling the fluid compressed by the sixth compression unit, and
the fourth support part is disposed above the third support part in the vertical direction and adjacent to the first support part in the horizontal direction and is transportable with the fifth cooling unit and the sixth cooling unit being fixed.

7. The compressor module according to claim 1, further comprising
a rotary drive machine including an output shaft rotationally driven about the axis and allowing the compressor to be driven by transmitting rotation of the output shaft, wherein
the rotary drive machine is disposed at a position not overlapping the first support part and the second support part when viewed from the vertical direction and is aligned with the compressor in the axial direction in which the axis extends.
